(19) United States
(12) Patent Application Publication
(10) Pub. No.: US 2009/0265572 A1
(43) Pub. Date: Oct. 22, 2009

(54) FAST ADAPTIVE VOLTAGE SCALING

(75) Inventors: Frank Heinle, Nuernberg (DE); Eckhard Walters, Roethenbach (DE)

Correspondence Address: SEED INTELLECTUAL PROPERTY LAW GROUP PLLC, 701 FIFTH AVENUE, SUITE 5400, SEATTLE, WA, 98104-7092, US

(73) Assignee: ST-ERICSSON SA, Geneva (CH)

(21) Appl. No.: 12/463,072

(22) Filed: May 8, 2009

Related U.S. Application Data
(63) Continuation-in-part of application No. PCT/IB2007/054383, filed on Oct. 29, 2007.

(30) Foreign Application Priority Data
Nov. 8, 2006 (EP) 06123682.4

(51) Int. Cl. G06F 1/08; G06F 1/26

(52) U.S. Cl. 713/500; 713/300

(57) ABSTRACT

A method, digital circuit, and computer program product control a supply voltage of a processing circuit based on a processing clock of the processing circuit. A first clock frequency and at least one second clock frequency are generated, wherein the first clock frequency is used as the processing clock and the second clock frequency is adjusted based on a clock control information issued by the processing circuit. A voltage conversion ratio for converting the supply voltage to a scaled supply voltage applied to the processing circuit is directly controlled in response to the result of a monitored performance under said second clock frequency. Thereby, a new fast automatic voltage scaling approach can be provided which allows to meet critical timing requirements of portable systems and to reduce power consumption significantly.

### BACKGROUND

1. Technical Field

The present disclosure relates to a method, computer program product and digital circuit for controlling a supply voltage of a processing circuit based on a processing clock of the processing circuit.

2. Description of the Related Art

In recent years, power consumption of processing systems has grown to be of crucial importance. The increased integration in embedded processing systems has led to an increase in their functional complexity. The trend towards portable systems demands for increased performance and low power consumption.

Performing a processing task within a given time constraint can be accomplished in different ways. In a scheme with fixed voltage and fixed clock frequency, the processor can be designed to operate at a supply voltage and clock frequency, which satisfy the timing constraint for the worst-case processing task under worst-case operating conditions. Hence, the processor is consuming energy even after the task has been accomplished. In an on/off scheme, energy is saved by operating the processor in a stand-by state where the processor clock is shut down after completion of the task. Thereby, energy can be saved with the additional advantage of simple implementation.

In a scheme with variable voltage and variable clock frequency, the clock frequency is scaled according to the timing constraints of the application. Rather than completing every task in the shortest time possible and waiting in stand-by mode until the next task, the processor lowers its clock frequency for low load tasks and increases its clock frequency for high load tasks while satisfying timing constraints under all operating conditions. In such a scheme, the supply voltage can be scaled with the clock frequency such that significant energy savings can be realized. At software level, this scheme requires the operating system or task scheduler to provide a variable clock frequency to the processor. At hardware level, this scheme requires a controller that varies the supply voltage to the processor to a value that is sufficient for correct operation under the given clock frequency.

However, in recent years a large number of power hungry features such as large color displays and multi-media capabilities have been added to portable systems, such as, for example, mobile or cellular phones. With the advent of third generation (3G) cellular phones power consumption became even more critical. Due to complex signal processing and software protocols, the baseband power consumption is again a very visible part of the overall power budget. Therefore, new concepts such as adaptive voltage scaling (AVS) are investigated in order to reduce power consumption. AVS is a scheme similar to the above-mentioned last scheme with variable voltage and variable frequency. The instantaneously required minimum clock speed is determined and the voltage is reduced such that the digital logic is able to run at just this minimized clock speed. Since the power is proportional to the square of the voltage, a large reduction of power consumption can be achieved. The US686850B1 discloses an example of a processing system with such AVS scheme.

To cope with the enhanced processing requirements, an embedded vector processor (EVP) has been developed, which is going to address the required high-rate signal processing formerly handled by hardware. Due to the very dynamic nature of modern systems, such as the Universal Mobile Telecommunications Systems (UMTS) for example, the processor load is highly varying and offers a lot of opportunities for power savings by AVS. Unfortunately, additional timing constraints may have to be considered. As an example, UMTS employs a so-called fast power control which implies the reception of so-called transmit power control (TPC) bits every 666 μs and a high peak processor load for the demodulation of these bits. A reduction of this peak load, e.g., by spreading the processing in time and a corresponding reduction of the voltage is prevented by strict timing constraints defined by the UMTS standard.

In conventional AVS systems, a chip-external power management integrated circuit is provided to be controlled via a serial interface. Accordingly, loop bandwidth must be sufficiently slow, so that conventional AVS concepts are by far not agile enough to follow the fast variation of the processor load and thus do not allow to reduce the clock speed. Even if the voltage could be modified with such a fast time granularity, the power consumption overhead for voltage scaling would be unacceptably high.

### BRIEF SUMMARY

One embodiment provides a fast voltage scaling scheme which allows to meet important timing specifications while reducing power consumption.

Accordingly, the proposed solution enables fast and direct voltage conversion by controlling the conversion ratio based on a parallel monitoring of system performance under the second clock frequency. The suggested direct voltage conversion function can be directly controlled by the scaling control function without any intermediate communication via a power management function or power supply unit. Thereby, an on-chip implementation is possible, which enables fast voltage conversion without requiring any serial interface for communication between a conventional (external) power management unit and an AVS circuitry (e.g., AVS processor or other AVS control circuit). The conversion rate can be directly controlled without requiring any additional communication between the power management unit and the AVS circuitry. This allows the scaling operation to follow even fast changing processing loads and to better exploit voltage reduction/power savings potentials of the processing circuit. The proposed new fast scaling concept thus allows for reducing the higher power consumption of, e.g., the EVP compared to dedicated hardware. Therefore, all advantages of fully programmable solutions such as flexibility and future-proof can be exploited without paying a significant penalty for power consumption.

The performance monitoring unit may be adapted to receive the second clock frequency and the scaled supply voltage, to verify whether a digital logic can be operated with the scaled supply voltage at the second clock frequency, and to output a monitoring result to the scaling controller. Thereby, the performance can be monitored in a comparable environment to obtain a reliable monitoring result. In a particular example, the performance monitoring unit may be configured to output the monitoring result as information indicating at last one of whether the scaled supply voltage is too high or too low. This binary information can easily be processed and leads to a reduced complexity.

The clock generating unit may be adapted to apply the first clock frequency as the processing clock to said processing circuit before and during control of the supply voltage. This option ensures that the controlled processing circuit may continue with proper operation during performance monitoring and voltage adjustment.

Furthermore, the voltage converter may comprise a DC-DC converter which receives said supply voltage as a constant supply voltage. The DC-DC converter enables direct and fast voltage adaptation so as to obtain a fast AVS loop.

The processing circuit, said clock generating unit, said voltage converter and said scaling control unit or circuit may be integrated on a single chip, such as a 65-nm or 45-nm CMOS chip for example, and be configurated in order to form an on-chip integrated processing loop. Such an on-chip solution ensures a fast scaling operation required for fast processing systems. The fast AVS on-chip loop reduces the delay conventionally introduced due to off-chip power supply units and required serial interfaces, and may need no external components.

Further advantageous embodiments are defined in the dependent claims.

### BRIEF DESCRIPTION OF THE SEVERAL VIEWS OF THE DRAWINGS

In the following, one embodiment will be described in greater detail with reference to the accompanying drawings in which:

FIG. 1 shows a schematic block diagram of a digital circuit with a voltage scaling functionality according to the embodiment;

FIG. 2 shows a timing relationship between uplink and downlink slots with a critical timing constraint;

FIG. 3 shows a schematic flow diagram of a voltage scaling procedure according to the embodiment; and

FIG. 4 shows a schematic signaling diagram indicating scaling results of the embodiment.

### DETAILED DESCRIPTION

The embodiments of the present disclosure will now be described in greater detail based on a fast AVS concept for an exemplary portable UMTS device, such as a mobile phone. The fast AVS concept allows to fully exploit the power saving opportunities offered by an EVP based approach, in which the EVP may be adapted to address the complete high-rate UMTS signal processing formerly handled by discrete hardware. It is however stressed that the concepts described hereinafter can be applied to any voltage scaling operation in any digital system.

In portable UMTS mobile phones most of the baseband processing may be handled by dedicated highly parallelized hardware, which is intended to be clocked as low as possible. Unused parts are intended to be shut down completely, e.g., by means of clock gating as a power savings measure.

Due to the very dynamic nature of a UMTS system, the processor load is highly varying and offers a lot of opportunities for power savings by AVS. Unfortunately, UMTS employs so-called fast power control which implies the reception of so-called transmit power control (TPC) bits (e.g., every 666 μs) and a high peak processor load for the demodulation of these bits. A reduction of this peak load, e.g., by spreading the processing in time and a corresponding reduction of the voltage is prevented by strict timing constraints defined by the UMTS standard.

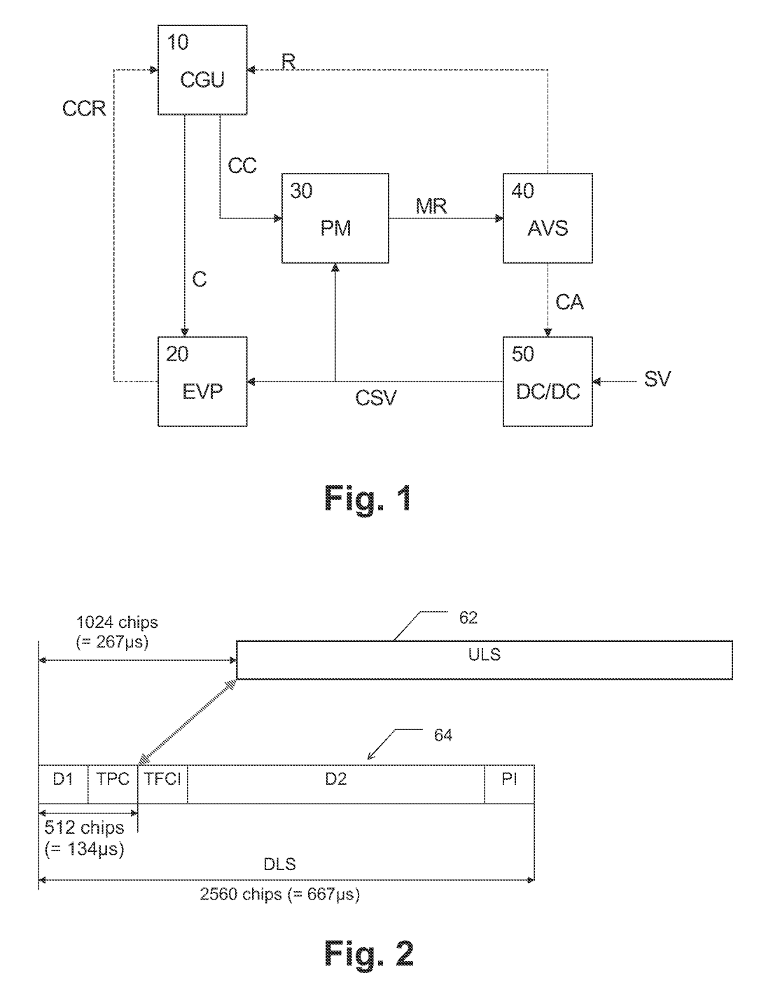

The UMTS standard defines a very critical timing constraint as shown in FIG. 2.

According to FIG. 2, a downlink (DL) slot 64 (which may have a length of 667 ms) comprises a first data portion (D1), a transmit power control (TPC) bit, a transport format combination indicator (TFCI) information, a second data portion (D2), and a pilot information (PI).

The TPC bit tells the handset whether the uplink transmit power needs to be increased or decreased. The time shift between the DL slot 64 and the uplink slot 62 is 1024 chips (=267 μs). According to the standard, the reception and decoding of the TPC bit has to happen within 512 UMTS chips (=134 μs), wherein the bits of the UMTS spreading signal are called “chips”. This time constraint is indicated by the bold arrow in FIG. 2. Due to various implementation constraints the processing time for the TPC reception, the TPC decoding and the transmit power setting is reduced to around 188 chips (=49 μs). Therefore, the reception/decoding process on the EVP needs to be sufficiently fast which can be ensured by running the core at the full or sufficiently high clock speed as long as the TPC is received and decoded. The processing load during the remaining part of the slot depends on the use case and can be comparatively low. Therefore, clock and voltage scaling applied during this time frame has the potential for significant power savings. However, the TPC is arriving periodically with the slot rate, i.e., every 666 μs. This fast recurrence requires a very agile AVS loop.

FIG. 1 shows a schematic block diagram of a digital circuit with a fast AVS loop according to the embodiment, which may be implemented with fast on-chip components.

An EVP 20 is the master of the system and knows its own clocking requirements. In one phase, the EVP 20 uses a processing clock C that it receives from a clock generating unit (CGU) 10. In a phase with higher clock requirements it requests a faster processing clock from the CGU 10, e.g., by issuing a clock change request CCR or another suitable control information or signal to the CGU 10.

The CGU 10 then generates a second clock CC with a changed clock frequency according to the new clocking requirement indicated by the clock change request CCR. The second clock is sent to a performance monitor 30 which receives a scaled supply voltage CSV (e.g., in a range from 0.6V to 1.35V in 65-nm CMOS process technology) via a directly controlled voltage converter, implemented in the exemplary embodiment as a fast on-chip DC-DC converter 50, and signals to an AVS circuit 40 (e.g., an AVS processor, AVS control unit, AVS controller, or any other AVS control circuit) by a monitoring result MR whether the hardware is able to run with the required clock speed (clock frequency) of the second clock CC at the given voltage CSV.

If the scaled supply voltage CSV is too low, i.e., if all of the change states of the digital logic of the digital circuit take longer than the clock cycle, the AVS circuitry 40 increases the voltage by directly adjusting the conversion rate of the DC/DC converter 50 via a control output CA (i.e., control signal or control information, which may be derived from a look-up table stored in the AVS circuitry 40 in order to correct the error signal generated by the difference between the desired CSV and the actual CSV). As soon as the scaled supply voltage CSV is high enough, i.e., as soon as all of the change states of the digital logic of the digital circuit are carried out within one clock cycle, the AVS circuitry 40 issues a control signal or information R to the CGU 10 to release the new second clock CC as new processing clock C to the EVP 20. The scaling operation of the AVS circuitry 40 may be performed in small voltage steps, e.g., 10 mV. Assuming for example a total range of 750 mV (e.g., from 1350 mV to 600 mV), this would mean 75 steps. However, in order to avoid processing overhead in the EVP 20, load granularity can be limited to much larger grains (e.g., 4 to 8 steps may be sufficient).

It is noted that the voltage steps may follow the clock steps. If the clock is increased, the voltage is also increased to make sure that all state changes in the processor circuitry are done within a processor clock cycle. So, the number of voltage steps may be the same as the number of clock steps. The voltage may be considered too low, if the delay for digital circuitry is too high, i.e., if the state changes of the digital circuitry take longer than the clock cycle. This may be determined by referring to the IC characterization. The results of the characterization may be stored in the look-up table provided at the AVS circuitry 40.

The EVP 20 may be a programmable EVP for addressing all UMTS signal processing tasks. This processor has a potentially very dynamic load profile and thus offers lots of opportunities for AVS. The CGU 10 is adapted to supply the two different clocks C and CC as tunable or fine tunable clocks. The first clock C may be supplied to the EVP 20 before and during the clock and voltage scaling, whereas the other second clock CC is the changed clock, which is going to be supplied to the EVP 20 after the scaled voltage CSV has been detected by the performance monitor 30 and after the AVS circuitry 40 has adjusted and stabilized a new voltage for the EVP 20.

Furthermore, the on-chip DC-DC converter 50 generates the reduced or increased supply voltage CSV from a constant external supply voltage SV without requiring any serial interface to a power management unit or the like. The DC-DC converter 50 can be optimized while being made faster with ultra-high clock frequency for small components (e.g., inductors and/or capacitors) as well as power-efficient voltage level up/down-ramping. In general, fast DC-DC converters are characterized by high clock frequency, e.g., in the range of typically 5 MHz. Therefore, nearly no or very small inductors (L) or capacitors (C) are required which can even be implemented on chip. The small L and C result in a very fast regulation loop. This allows for very fast and fine grained voltage profiles and on-chip integration (cost reduction). In particular the fast voltage changes as required for example in UMTS system (e.g., less than 666 μs) can be achieved. Thus, the DC-DC converter can be optimized to maximize the DC-DC converter clock frequency in order to keep the L and C small and to achieve the above-mentioned advantages.

The two different clocks C and CC are thus both generated in the CGU 10 for the EVP 20. The first is used whereas the second one is stabilized. As soon as it is stable the clocks are swapped. The maximum clock frequency can be in the order of hundreds of MHz (e.g., typical processor clock frequency) and can be scaled down to even kHz only if the processor is not heavily loaded. The ultra-high frequency in fact thus refers to an internal clock of the DC-DC converter which is not active outside the DC-DC converter 50. It may be in the range of 5 MHz as mentioned above.

The performance monitor 30 is adapted to verify that the digital logic of the circuit is capable of running at the desired clock speed with a given voltage, i.e., the scaled 25 supply voltage CSV. More precisely, the monitored performance will be positively assessed when all of the change states of the digital logic of the digital circuit are carried out within one clock cycle and negatively assessed when the next clock cycle appears before they are carried out. The AVS circuitry 40 is adapted to directly adjust the DC-DC converter 50 via the control output CA such that the EVP 20 and the performance monitor 30 are supplied with a lower/higher supply voltage CSV depending on the requested clock speed. Further to this, the AVS circuitry 40 enables or releases the new clock CC in the CGU 10 as soon as the new voltage has been adjusted.

The above-mentioned building blocks of FIG. 1 may be fully or partly integrated on a single chip such that a fast on-chip integrated AVS loop can be closed. This integration which is made possible by the proposed direct AVS control of the voltage conversion function allows to follow fast changing processing load requirements of UMTS and to exploit the voltage reduction/power savings potential of the UMTS standard. This fast AVS concept allows for reduction of the higher power consumption of the EVP compared to dedicated hardware.

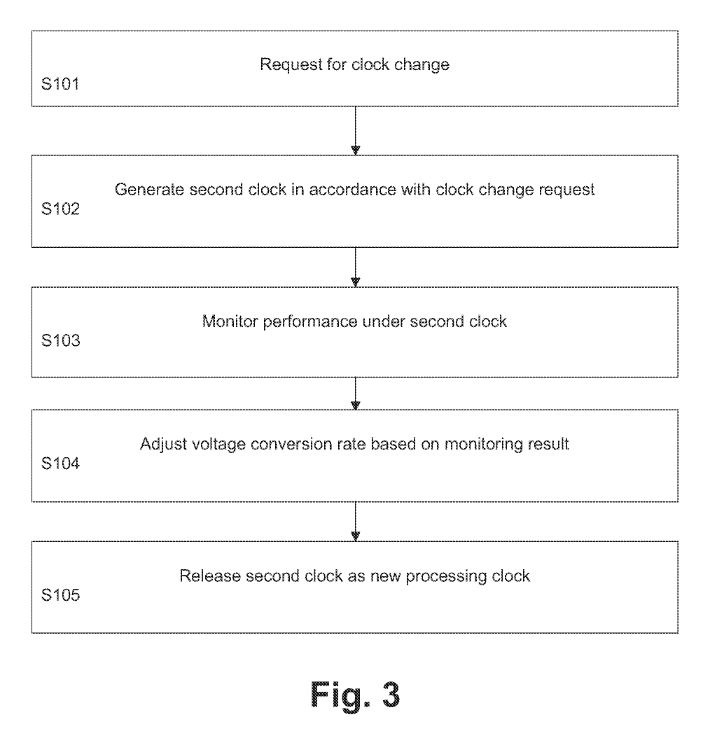

FIG. 3 shows a schematic flow diagram of general processing steps involved in the proposed AVS procedure according to the embodiment.

In a first step S101, a request for change of the processing clock is issued by or derived from the controlled processing circuit, e.g., the EVP 20 of FIG. 1. In response to this request, the adapted second clock CC is generated in step S102. Then, in step S103, the performance of the digital circuitry under the changed second clock CC is monitored, e.g., based on specific performance parameters (such as delay, power, timing requirements, etc.) suitable for evaluating proper operation of digital circuits.

Based on the monitoring result obtained from step S103, the voltage conversion rate used for converting the external supply voltage SV into the scaled supply voltage CSV is adjusted to thereby adapt the scaled supply voltage CSV to the requirements of the digital circuitry.

Finally, when the monitoring result indicates proper operation, the second clock CC is released as new processing clock C to be supplied to the controlled processing circuit.

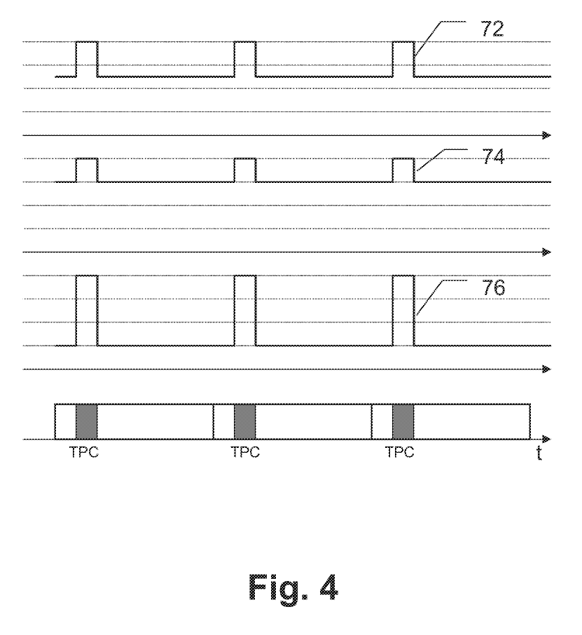

Eventually, the EVP 20 may be running at a higher voltage in order to get a clock faster than a typical processor clock in the order of a few hundreds of megahertz, which is just high enough to support the higher clock speed. The same type of loop is then employed for reducing the voltage if only a slower clock speed is desired. This may be implemented in the same loop or a second loop. Thereby, an overdrive mode can be achieved, where the voltage is increased above the nominal supply voltage which may lead to around 20% higher clock speeds than specified. Again, clock speed may be a typical processor clock speed with a few hundreds of MHz. The described approach allows to follow fast processor load fluctuations as shown in FIG. 4.

FIG. 4 shows a signaling diagram which indicates a clock waveform 76 of the processing clock C, a voltage waveform 74 of the scaled supply voltage CSV, and a power waveform 72 of the resulting power consumption at the controlled circuit, together with the corresponding location of the TPC bit within the slots of the UMTS signal.

In the example of FIG. 4, 100% of the speed or frequency (f) of the clock signal C is assumed during 512/2560=20% of a slot and 25% of the clock speed during the remaining 80%. It is further assumed that the scaled supply voltage CSV (V) is reduced to 75% during the phases with low processor load. It has also to be taken into account that the power consumption (P) in a CMOS circuit yields P˜V²f. Therefore, the average power consumption with the proposed fast AVS will be 0.2×1²×1+0.8×0.75²×0.25=31% compared to a processor running with full clock speed all the time.

Without the proposed fast AVS the processor would run with full speed for the whole TPC and for 25% of the remaining time. All the time the maximum voltage would be applied. The average power consumption in this scenario would be 0.2×12×1+0.25×0.8×1²×1=40% compared to a processor running with full speed all the time.

Obviously, the fast AVS in this case yields a significant power consumption reduction of 1-31/40=23% compared to conventional approaches.

In a software-based implementation of the digital scaling circuit of FIG. 1, the AVS circuitry 40, the performance monitor 30 and the DC-DC converter 50 or at least a part thereof may be implemented by a processor or computer device with a control unit which performs control based on software routines of a control program stored in a memory. Program code instructions are fetched from the memory and loaded to the control unit of the processing unit in order to perform at least a part of the processing steps of the above functionalities described in connection with FIG. 3. These processing steps are then configured to generate the control signaling required at the respective functionality.

As an example, a software modem for cellular systems may be provided, which is implemented as a program running on the EVP 20. This embodiment is suitable for cellular systems where the timing is determined by a cellular standard and must not be violated. Furthermore, there are other real-time constrained processing applications, e.g., audio/video streaming with encoding and decoding, in which the proposed adaptive voltage scaling can be implemented. But also a WLAN (wireless local area network) OFDM (Orthogonal Frequency Division Multiplexing) modem is constrained and challenged in the same way. It thus can be expected that the proposed integration of DC/DC converters on a digital chip can be implemented in various and increasing fields of application in order to simplify the systems, so that AVS loops can be applied without external components.

In summary, a method, digital circuit, and computer program product have been described for controlling a supply voltage of a processing circuit based on a processing clock of the processing circuit. A first clock frequency and at least one second clock frequency are generated, wherein the first clock frequency is used as the processing clock and the second clock frequency is adjusted based on a clock control information issued by the processing circuit. A voltage conversion ratio for converting the supply voltage to a scaled supply voltage applied to the processing circuit is directly controlled in response to the result of a monitored performance under said second clock frequency. Thereby, a new fast automatic voltage scaling approach can be provided which allows to meet critical timing requirements of portable systems and to reduce power consumption significantly.

It is to be noted that the present invention can be applied to any processing circuit required for wireless or other non-wireless system in any technical field with fast control loops requiring a temporarily high processor load but otherwise low computational requirements. As an example, referring to FIG. 2, the processor in this specific application is loaded with close to 100% indicated by the red arrow in order to meet UMTS specific timing requirements. During the remaining time the timing are relaxed and the processor is only loaded with 25% which means that the processor clock can be reduced in order to save power. However, this is just an example, in a different application the load situations could be completely different. The CGU 10 of FIG. 1 may be adapted to generate more than one second clock at different frequencies (speeds) to enable even faster change and/or performance monitoring. The other second clocks may be higher or lower than the processing clock, or may be successively higher or lower, e.g., to enable parallel performance monitoring. The performance monitoring may typically be done by measuring delays which give an indication whether the circuit can be clocked with the selected frequency without failure. In connection with the judgment or categorization of measured performance, it may be judged as “fine” or “sufficient” if for example all state changes of all digital circuits are stabilized within one clock cycle. In contrast thereto, the measured performance may for example be judged as “insufficient” if the next clock cycle appears before the digital signals are stable.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A digital circuit for controlling a supply voltage of a processing circuit based on a processing clock of said processing circuit, said digital circuit comprising:
a clock generating unit configured to generate a first clock frequency and a second clock frequency, wherein said first clock frequency is configured to be used as said processing clock and said second clock frequency is adjusted based on clock control information issued by said processing circuit;
a voltage converter configured to convert said supply voltage into a scaled supply voltage applied to said processing circuit; and
a scaling control unit configured to directly control a conversion ratio of said voltage converter in response to a monitored performance under said second clock frequency and for controlling said clock generating unit to release said second clock frequency as said processing clock.

2. The digital circuit according to claim 1, further comprising a performance monitoring unit configured to receive said second clock frequency and said scaled supply voltage, to verify whether a digital logic circuit can be operated with said scaled supply voltage at said second clock frequency, and to output a monitoring result to said scaling controller.

3. The digital circuit according to claim 2, wherein said performance monitoring unit is configured to output said monitoring result as an information indicating at least one of whether said scaled supply voltage is too high or too low.

4. The digital circuit according to claim 1 wherein said processing circuit comprises an embedded vector processor.

5. The digital circuit according to claim 1 wherein said clock generating unit is configured to apply said first clock frequency as said processing clock to said processing circuit before and during control of said supply voltage.

6. The digital circuit according to claim 1 wherein said voltage converter comprises a DC-DC converter which receives said supply voltage as a constant supply voltage.

7. The digital circuit according to claim 1 wherein said clock control information comprises at least one of a request for a faster clock and a request for a slower clock.

8. The digital circuit according to claim 1 wherein said processing circuit, said clock generating unit, said voltage converter and said scaling control unit are integrated on a single chip.

9. The digital circuit according to claim 8, wherein said processing circuit, said clock generating unit, said voltage converter and said scaling control unit are arranged close together to form an on-chip integrated processing loop.

10. A method, comprising:
controlling a supply voltage of a processing circuit based on a processing clock of said processing circuit, the controlling including:
generating a first clock frequency and a second clock frequency, wherein said first clock frequency is used as said processing clock;
adjusting said second clock frequency based on clock control information issued by said processing circuit;
directly controlling a conversion ratio of a voltage conversion function to convert said supply voltage into a scaled supply voltage applied to said processing circuit; and
releasing said second clock frequency as said processing clock.

11. The method of claim 10, further comprising verifying whether a digital logic circuit can be operated with said scaled supply voltage at said second clock frequency, wherein directly controlling the conversion ratio includes directly controlling the conversion ratio based on the verifying step.

12. The method of claim 10, further comprising applying said first clock frequency as said processing clock before and during control of said supply voltage.

13. The method of claim 10, wherein said clock control information comprises at least one of a request for a faster clock and a request for a slower clock.

14. A computer-readable medium having contents that cause a processor device to perform a method including:
controlling a supply voltage of a processing circuit based on a processing clock of said processing circuit, the controlling including:
generating a first clock frequency and a second clock frequency, wherein said first clock frequency is used as said processing clock;
adjusting said second clock frequency based on clock control information issued by said processing circuit;
directly controlling a conversion ratio of a voltage conversion function to convert said supply voltage into a scaled supply voltage applied to said processing circuit; and
releasing said second clock frequency as said processing clock.

15. The computer-readable medium of claim 14, wherein the method includes verifying whether a digital logic circuit can be operated with said scaled supply voltage at said second clock frequency, wherein directly controlling the conversion ratio includes directly controlling the conversion ratio based on the verifying step.

16. The computer-readable medium of claim 14, wherein the method includes applying said first clock frequency as said processing clock before and during control of said supply voltage.

17. The computer-readable medium of claim 14, wherein said clock control information comprises at least one of a request for a faster clock and a request for a slower clock.

18. A portable device, comprising:
a processing circuit configured to operate using a processing clock and a supply voltage; and
a digital circuit configured to control the supply voltage of the processing circuit based on the processing clock of said processing circuit, said digital circuit including:
a clock generating unit configured to generate a first clock frequency and a second clock frequency, wherein said first clock frequency is configured to be used as said processing clock and said second clock frequency is adjusted based on clock control information issued by said processing circuit;
a voltage converter configured to convert said supply voltage into a scaled supply voltage applied to said processing circuit; and
a scaling control unit configured to directly control a conversion ratio of said voltage converter in response to a monitored performance under said second clock frequency and for controlling said clock generating unit to release said second clock frequency as said processing clock.

19. The portable device of claim 18, wherein the digital circuit includes a performance monitoring unit configured to receive said second clock frequency and said scaled supply voltage, to verify whether a digital logic circuit can be operated with said scaled supply voltage at said second clock frequency, and to output a monitoring result to said scaling controller.

20. The portable device of claim 18, wherein said clock generating unit is configured to apply said first clock frequency as said processing clock to said processing circuit before and during control of said supply voltage.
